(19) United States
(12) Patent Application Publication
(10) Pub. No.: US 2024/0352162 A1
(43) Pub. Date: Oct. 24, 2024

(54) PROCESS FOR POLYMERIZATION OF ETHYLENE USING A COOLING SYSTEM WITH A SLURRY-FREE HEAT EXCHANGER

(71) Applicant: Braskem S.A., Camaçari (BR)

(72) Inventors: Edmundo Ferreira Barros Filho, São Paulo (BR); Fernando da Silva Gomes, São Paulo (BR); Juliano Rosa Dos Santos Muller, São Paulo (BR); Tahyná Barbalho Fontoura, São Paulo (BR); Dihogenes Adriano Pozzer, São Paulo (BR); Edwin Towsend, São Paulo (BR)

(73) Assignee: Braskem S.A., Camaçari (BR)

(21) Appl. No.: 18/640,514

(22) Filed: Apr. 19, 2024

Related U.S. Application Data
(60) Provisional application No. 63/497,409, filed on Apr. 20, 2023.

(51) Int. Cl. C08F 10/02; B01J 19/00

(52) U.S. Cl. CPC C08F 10/02; B01J 19/0013; B01J 2219/00076

(57) ABSTRACT

Provided is a process for the polymerization of ethylene comprising introducing ethylene, a liquid light hydrocarbon diluent, at least one catalyst, at least one cocatalyst, and optionally one or more comonomers into a reactor; polymerizing the ethylene and optionally the one or more comonomers in the reactor to produce an ethylene polymer; wherein the reactor is fluidly connected to a cooling system, the cooling system comprising a slurry-free heat exchanger, and the cooling system is configured to receive a vapor stream comprising light hydrocarbon vapor produced in the reactor. Also provided is an ethylene polymer produced from the process for polymerizing ethylene and a system for producing an ethylene polymer.

### BACKGROUND

Very High Molecular Weight Polyethylene (VHMWPE) or Ultra High Molecular Weight Polyethylene (UHMWPE) is a very special class of polyethylene which, due to its very high molecular weight, is characterized by a unique combination of properties making it suitable for applications where lower molecular weight grades fail.

Both polymers have a linear chain-like structure and are semicrystalline polymers with medium density and a few branches. It is classified as Very High Molecular Weight Polyethylene (VHMWPE) when the material has a viscosity molecular weight (Mv) ranging from 0.2 to 3.0 Mg/mol and it is classified as Ultra High Molecular Weight Polyethylene (UHMWPE) when the material has a viscosity molecular weight (Mv) higher than 3.0 Mg/mol. In the context of the present invention, both VHMWPE and UHMWPE will be referred to as UHMWPE.

UHMWPE has excellent mechanical properties such as high impact toughness, high abrasion resistance, and fatigue resistance, and has good corrosion, chemical, and radiation resistance. The UHMWPE processing requires that the polymer powder has a low particle size of less than 300 microns, preferably within a range of 100 to 250 microns.

The high molecular weight of the polymers impairs their processability, mainly due to the increased number of entanglements per chain. High entanglement density confers excellent mechanical properties in the end application. However, it also increases the polymer melt viscosity, reducing the mobility of the polymer chains in the melt during processing causing poor homogeneity of the processed product obtained from such a high molecular weight material.

UHMWPE is classified as an engineering plastic due to its excellent properties, including high impact and abrasion wear resistance. It also has a very low coefficient of friction, which gives the material a self-lubricating property. It is used in several fields, such as construction, food, beverages, automotive, military, paper and cellulose, agricultural machines, and others.

Chemically speaking, UHMWPE is classified as polyethylene because of its composition, containing only carbon and hydrogen. However, any similarity to common polyethylene broadly used in consumer goods and packaging industries stops there. The main difference between UHMWPE and regular polyethylene products is its chain size, which results in a molecular weight usually 10 times larger than high-density polyethylene (HDPE) grades, for example. Such difference in molecular weight leads to completely different properties and applications.

The control of the powder morphology is another significant difference between the HDPE and UHMWPE processes. HDPE is extruded, and it is delivered as a pellet product, whereas UHMWPE is delivered as a powder as it cannot be extruded in the usual extruder systems due to its very high melt viscosity. Therefore, powder morphology is an important parameter in product quality because the UHMWPE is handled as a powder in its subsequent transformation processes.

The current process to produce UHMWPE is a continuous operation that polymerizes ethylene monomer in the presence of a Ziegler-Natta catalyst in a heavy hydrocarbon diluent as a reaction medium. The polymerization occurs in a Continuous Stirred Tank Reactor (CSTR), where the purified raw materials, catalyst, cocatalyst, antistatic agent, and diluent are fed. N-hexane is the usual heavy hydrocarbon diluent, it is used to dilute the powder to generate a slurry (mixture of diluent and polymer) and it is also the medium to supply the ethylene monomer to the catalyst. An agitator is used to keep the powder in turbulent suspension. The polymerization reaction is exothermic, and the diluent acts as a heat transfer medium to remove the heat generated in the ethylene polymerization reaction. The heat removal is done in the reactor jacket and in the external heat exchangers, where the slurry from the reactor is pumped through the heat exchanger and it is sent back to the reactor. The polymerization occurs continuously in at least one reactor with control of pressure, temperature, reactants concentration, and additive concentration, in order to produce the polymer with the desired characteristics. After the residence time in the reactors, the suspension of polymer flows from the reactor to a flash vessel, where the unreacted gases are separated from the polymer and the diluent by reducing the pressure of the stream. The gas flows from the flash vessel to the compressors from where it is recycled to the reactors. There is a purge from the compressor discharge to the flare to avoid built-up of inert in the recycle gas circuit. The slurry from the flash vessel is sent by pump to the centrifuge where most of the diluent is separated from the powder. The powder is further separated from the solvent by drying with heated nitrogen. The diluent separated from the powder is majorly pumped back to the reactor and a small part of this heavy hydrocarbon diluent is sent to a purification system where the heavy components are separated. The polymer in the form of powder is transferred to a packing area where small amounts of chemical additives are added.

Fouling is one of the main issues in this process where there is a formation of polymer film on the internal walls of the reactor, pipes, and heat exchangers, buildup of polymer chunks, and equipment and pipe obstructions by agglomerated polymer particles. Fouling decreases the heat removal capacity of heat exchangers and obstructs or even stops the slurry flow in the pipes.

One of the reasons for fouling is the electrical static charge generated by friction among the polymer particles and between the particle and equipment surface. The static energy causes the particles to agglomerate to coarse particles and to adhere to the internal surfaces of reactor walls, stirrers, pipes, and heat exchangers. This causes the plugging of heat exchanger tubes and slurry pipes, decreasing heat removal capacity and slurry flow transfer.

Antistatic agents are used as a processing aid to dissipate the electrical charge to the reactor wall, and they also have surfactant action to avoid particle agglomeration. Antistatic agents prevent particles from sticking on the wall surface and agglomerating, thereby preventing the loss of heat exchanging capability and line blockage/plugging and reducing maintenance requirements and unit downtime. However, the dissipation of electrical static charge may demand a high dosage of antistatic agent, which affects the variable production cost and the catalyst performance.

Therefore, there is a need to develop processes for the polymerization of ethylene where fouling is reduced in equipment such as heat exchangers, pipes, and reactors, especially in the heat exchanger pipes in a way to prevent or mitigate the decrease of heat removal capacity.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a process for the polymerization of ethylene comprising:
introducing ethylene, a liquid light hydrocarbon diluent, at least one catalyst and optionally one or more comonomers into a reactor;
polymerizing the ethylene and optionally the one or more comonomers in the reactor to produce an ethylene polymer;
wherein the reactor is fluidly connected to a cooling system, the cooling system comprising a slurry-free heat exchanger, and the cooling system is configured to receive a vapor stream comprising light hydrocarbon vapor produced in the reactor.

In another aspect, the present disclosure relates to an ethylene polymer obtained by the process described herein.

In a further aspect, the present disclosure relates to a system for producing an ethylene polymer comprising:
a reactor receiving a liquid light hydrocarbon diluent, ethylene, at least one catalyst, and optionally one or more comonomers configured to polymerize the ethylene and optionally the one or more comonomers into an ethylene polymer;
a cooling system fluidly connected to the reactor, wherein the cooling system is configured to condense a light hydrocarbon vapor produced in the reactor and return a condensed liquid light hydrocarbon to the reactor.

### BRIEF DESCRIPTION OF DRAWINGS

FIG. 1 shows the condenser before and after the polymerization runs of examples 2, 3 and 4. FIG. 1A shows the condenser before the polymerization runs of examples 2, 3 and 4.

FIG. 1B shows the condenser after the polymerization runs of examples 2 and 3. FIG. 1C shows the condenser after the polymerization run of example 4.

FIG. 2 shows a process flow diagram according to one or more embodiments of the process according to the present disclosure.

### DETAILED DESCRIPTION

Embodiments of the present disclosure are directed to a process for polymerizing ethylene using a light hydrocarbon diluent and cooling system with a slurry-free heat exchanger, wherein fouling in the cooling system, particularly in the heat exchanger, is reduced or prevented.

Advantageously, such a process may overcome the drawbacks of the prior systems. The process for polymerization according to the present disclosure may also reduce the dosage of antistatic needed in the process, so the variable cost is also reduced. The process according to the present disclosure may also show higher catalytic activity when compared to the process of the prior systems. The process according to the present disclosure may also discard the need for an external heat exchanger after polymerization to cool the slurry down (also referred to as a “slurry cooler”).

Moreover, by a light hydrocarbon diluent, the process according to the present disclosure facilitates the removal of diluent in the polymer powder, and a lower content of volatile organic compounds (VOC) in the final product is achieved when compared to the prior systems. Also, the process according to the present disclosure may require less energy and utilities for using a light hydrocarbon diluent, therefore reducing the operational expenditure when compared to the prior systems.

### Process for Polymerization of Ethylene

Embodiments disclosed herein are directed to a process for polymerization of ethylene comprising:
introducing ethylene, a liquid light hydrocarbon diluent, at least one catalyst, at least one cocatalyst and optionally one or more comonomers into a reactor;
polymerizing the ethylene and optionally the one or more comonomers in the reactor to produce an ethylene polymer;
wherein the reactor is fluidly connected to a cooling system, the cooling system comprising a slurry-free heat exchanger, and the cooling system is configured to receive a vapor stream comprising light hydrocarbon vapor produced in the reactor.

The process according to the present disclosure may be operated under any operational mode known in the art, for example, batch, semi-batch, or continuously. In a preferred embodiment, the process according to the present disclosure is operated continuously.

In a preferred embodiment, the polymerization according to the present disclosure is a liquid-phase polymerization, preferably a suspension-type polymerization wherein a slurry is formed inside the reactor, also referred to as slurry-phase polymerization.

In a preferred embodiment, the reactor wherein the polymerization occurs, also referred to herein as “polymerization reactor”, is selected from a continuous stirred tank reactor (CSTR). In a preferred embodiment, the polymerization reactor may have baffles in the form of square-edged, sharp, smooth, or round shapes to improve mixing and avoid vortex behavior. For the purposes of the present invention, the term “reactor” may also refer to a set of reactors connected in series, in parallel, or a combination of these types of settings. In embodiments where more than one reactor is used, each reactor may have its cooling system defined according to the present disclosure, or the cooling system or cooling systems may be shared between two or more reactors.

The polymerization of ethylene according to the present disclosure occurs in the presence of at least one catalyst. The catalysts for the process according to the present disclosure are not particularly limited and may be selected among any type of catalyst capable of catalyzing ethylene polymerization. In a preferred embodiment, the at least one catalyst according to the present disclosure is selected from the group consisting of Phillips catalyst (Phillips-supported chromium catalyst), Ziegler-Natta, metallocene, or post-metallocene catalyst. In a more preferred embodiment, the at least one catalyst is selected from Ziegler-Natta and metallocene catalysts.

In a preferred embodiment, the process according to the present disclosure further comprises the step of pre-polymerizing the one or more catalysts with an ethylene monomer. For the purposes of the present invention, the term “pre-polymerization” and derivations thereof refers to a preliminary polymerization step that occurs before conveying the catalyst to the polymerization reactor. The pre-polymerization step may occur in a batch, semi-bath, or continuous mode, preferably in a batch or continuous mode. The reactor wherein the pre-polymerization takes place is referred to herein as a “pre-polymerization reactor”.

In a preferred embodiment, the catalyst pre-polymerization with ethylene monomer occurs in the presence of a second liquid hydrocarbon diluent. The liquid light hydrocarbon diluent of the polymerization and the second liquid hydrocarbon diluent of the pre-polymerization are independently selected from each other. In a preferred embodiment, the second liquid hydrocarbon diluent is an inert alkane, linear or branched, containing from 3 to 8 carbon atoms. In a preferred embodiment, the second hydrocarbon diluent is selected from propane, butane, isobutane, pentane, isopentane, n-hexane, n-heptane, or n-octane.

The polymerization of ethylene according to the present disclosure may occur in the presence of one or more comonomers. In a preferred embodiment, the one or more comonomers are selected from alpha-olefin comonomers, more preferably alpha-olefins containing from 3 to 10 carbon atoms. In a more preferred embodiment, the alpha-olefin comonomers are selected from propene, 1-butene, 1-hexene, 1-octene, or 1-decene.

In embodiments wherein one more comonomers are used in the polymerization, they may be combined with the ethylene monomer in situ (i.e., in the polymerization reactor) or combined with the ethylene monomer prior to introducing them into the polymerization reactor. In a preferred embodiment, the one or more comonomers are combined with the ethylene monomer prior to introducing them into the polymerization reactor.

Both the ethylene monomer and the one or more comonomers may need a preliminary purification step prior to introduction into the polymerization reactor and/or pre-polymerization reactor. The preliminary purification step is responsible for removing catalyst poison prior to these components being fed into the reactor. In a preferred embodiment, the ethylene monomer and/or the one or more comonomers are subjected to a raw material purification step prior to introduction into the polymerization reactor and/or pre-polymerization reactor.

For the purposes of the present invention, the term “light hydrocarbon diluent” refers to an inert hydrocarbon compound that dilutes the polymerization reaction medium. In a preferred embodiment, the light hydrocarbon diluent has a boiling point lower than 37° C., preferably lower than 28° C., more preferably lower than −10° C., and even more preferably lower than −40° C., at atmospheric pressure. In a preferred embodiment, the light hydrocarbon diluent is an inert alkane, linear or branched, containing from 2 to 5 carbon atoms, more preferably from 3 to 5 carbon atoms, even more preferably from 3 to 4 carbon atoms, most preferably 3 carbon atoms. In a preferred embodiment, the light hydrocarbon diluent is selected from ethane, propane, butane, isobutane, or pentane, even more preferably from propane, butane, or isobutane, most preferably from propane. In one or more embodiments, the light hydrocarbon diluent stream fed to the reactor is substantially free of n-hexane. For the present invention, the term “substantially free of n-hexane means a content lower than 10% by weight, more preferably lower than 5% by weight, more preferably lower than 1% by weight,, for example lower than 0.1% by weight, based on the total weight of the reactor content. In one or more embodiments, minor amounts of hexane may be present in the reactor content for being used as diluent for catalyst, cocatalyst and antistatic feed streams. In such context, it is to be understood that such n-hexane is not part of the hydrocarbon diluent feed.

In a preferred embodiment the at least one catalyst may be combined with the liquid light hydrocarbon diluent prior to introducing them into the reactor. In this embodiment, the catalyst may have been pre-polymerized with an ethylene polymer prior to the combination with the liquid light hydrocarbon diluent.

In a preferred embodiment, the process according to the present disclosure makes use of one or more process additives. The one or more process additives may be added to the polymerization reactor prior to or during polymerization. In a preferred embodiment the one or more additives are selected from the group consisting of antistatic agents. Antistatic agents useful for the process of the present disclosure are not particularly limited but may be preferably selected from dodecylbenzene sulfonic acid, dioctyl sulfosuccinate sodium salt, quaternary ammonium compounds with polymeric radical containing sulfur and/or nitrites, polyglycerol esters, polyglycerol esters of fatty acids, or mixtures thereof. In a preferred embodiment, the antistatic agent is dosed in an amount ranging from 1 to 200 ppm, based on the total weight of the reaction medium.

In a preferred embodiment, the process of the present disclosure further comprises adding one or more chain transfer agents (CTA) to the polymerization reactor. The one or more chain transfer agents may need a preliminary purification step prior to introduction into the polymerization reactor. The preliminary purification step is responsible for removing catalyst poison prior to the CTA being fed into the reactor. In a preferred embodiment, the one or more chain transfer agents are subjected to a raw material purification step prior to introduction into the polymerization reactor. Chain transfer agents useful for the process according to the present disclosure are not particularly limited to but are preferably selected from hydrogen, alkyl aluminum, or combinations thereof. The molar proportion between the chain transfer agent and ethylene monomer in the polymerization reactor may be responsible for controlling the molecular weight of the ethylene polymer. When chain transfer agents are used, they may be present in an amount ranging from 0.001 to 5.0 mol/mol, preferably from 0.001 to 1.0 mol/mol, and even more preferably from 0.001 to 0.05 mol/mol, based on the CTA/ethylene molar ratio in the polymerization reactor. The chain transfer agent may be present in an amount ranging from a lower limit of 0.001, 0.01, or 0.1 mol/mol to an upper limit of 0.05, 0.5, or 5.0 mol/mol where any lower limit may be used in combination with any suitable upper limit.

In a preferred embodiment, the process according to the present disclosure further comprises adding at least one cocatalyst to the polymerization reactor and/or to the pre-polymerization reactor. In embodiments wherein at least one cocatalyst is used, it may be mixed with the at least one catalyst in situ (i.e., in the polymerization reactor and/or in the pre-polymerization reactor) or pre-mixed with the at least one catalyst prior to introducing them into the polymerization reactor and/or pre-polymerization reactor. In a preferred embodiment, the at least one cocatalyst is premixed with the at least one catalyst before getting into the polymerization reactor. In a preferred embodiment, the at least one cocatalyst is mixed in situ with the at least one catalyst in the pre-polymerization reactor. In a more preferred embodiment, the at least one cocatalyst is mixed in situ with the at least one catalyst in the pre-polymerization reactor and premixed with the pre-polymerized at least one catalyst before getting into the polymerization reactor. Cocatalysts useful for the process of the present disclosure are not particularly limited to but preferably selected from alkyl aluminum cocatalysts.

In the process according to the present disclosure, the polymerization reactor is fluidly connected to a cooling system comprising a slurry-free heat exchanger, and the cooling system is configured to receive a vapor stream comprising a light hydrocarbon vapor produced in the polymerization reactor. In a preferred embodiment, the cooling system is configured to condense the light hydrocarbon vapor into a condensed liquid light hydrocarbon. The cooling heat transfer media responsible for condensing the light hydrocarbon vapor is not particularly limited as long as it is capable of receiving heat from the light hydrocarbon vapor. In a preferred embodiment, the cooling heat transfer media is water, and the cooling system is a water cooling system.

In a preferred embodiment, the light hydrocarbon vapor is produced in the polymerization reactor from the phase transition of the liquid light hydrocarbon introduced in the polymerization reactor. The phase transition of the liquid light hydrocarbon occurs by the heat of polymerization generated in the polymerization reactor.

In a preferred embodiment, the vapor stream produced in the polymerization reactor and received by the cooling system is substantially free of solids. Considering that the vapor stream may carry a small content of particles (also referred as “carryover”), particularly fine particles, the vapor stream may have up to 5% by weight of solids, preferably up to 1% by weight of solids, for example up to 0.5% by weight of solids, based on the total weight of the vapor stream. In a preferred embodiment, the vapor stream may have from 0 to 5% by weight of solids, more preferably from 0.001% to 5% by weight of solids, based on the total weight of the vapor stream. In a preferred embodiment, the vapor stream may have from 0 to 1% by weight of solids, from 0 to 2% by weight of solids, from 0 to 3% by weight of solids, from 0 to 4% by weight of solids, for example from 0.001% to 1% by weight of solids, from 0.001% to 2% by weight of solids, from 0.001% to 3% by weight of solids, 0.001% to 4% by weight of solids, based on the total weight of the vapor stream.

In the context of the present invention, the term “slurry-free heat exchanger” relates to a heat exchanger that receives a vapor stream produced from the polymerization reactor. In one or more embodiments, the “slurry-free heat exchanger” may also be referred to as a “solid-free heat exchanger”, in embodiments where the vapor stream produced from the polymerization reactor is substantially free of solids. The vapor stream being “substantially free of solids” means that it may have a small content of particles, particularly fine particles (for example due to solid carryover), in a way that “substantially free of solids” refers to a vapor stream having up to 5% by weight of solids, preferably up to 1% by weight of solids, based on the total weight of the vapor stream. In one or more embodiments, the vapor stream may have from 0 to 5% by weight of solids or from 0.001% to 5% by weight of solids, based on the total weight of the vapor stream. In one or more embodiments, the vapor stream may have from 0 to 1% by weight of solids, from 0 to 2% by weight of solids, from 0 to 3% by weight of solids, from 0 to 4% by weight of solids, for example from 0.001% to 1% by weight of solids, from 0.001% to 2% by weight of solids, from 0.001% to 3% by weight of solids, 0.001% to 4% by weight of solids, based on the total weight of the vapor stream. The vapor stream may also be free of solids. In the present disclosure, the “slurry-free heat exchanger” or “solid-free heat exchanger” may also be referred to as “condenser”.

After the condensation of the light hydrocarbon vapor in the cooling system, the condensed liquid light hydrocarbon may be preferably returned to the polymerization reactor by gravity or pumped back to the reactor. More preferably, the light hydrocarbon liquid is returned to the polymerization reactor by gravity.

In a preferred embodiment, the polymerization reactor is operated at temperature and pressure conditions capable of promoting the production of the vapor stream comprising the light hydrocarbon vapor. In a preferred embodiment, the polymerization reactor may be operated in a pressure range of 2 to 50 barg, preferably from 10 to 50 barg, more preferably from 20 to 40 barg. In a preferred embodiment, the polymerization reactor is operated at a temperature range from 30 to 120° C., preferably from 30° C. to 90° C., more preferably from 40° C. to 85° C.

The rate of conversion of the monomer in the process of the present disclosure is particularly high, advantageously varying from 70% to 95%, for example from 80% to 90%.

After the polymerization step, the process according to the present disclosure may further comprise the step of subjecting the reaction medium to a separation step wherein the light hydrocarbon diluent and non-reacted monomers are separated from the ethylene polymer. In a preferred embodiment, this step is operated in a flash vessel. In a preferred embodiment, the separated light hydrocarbon diluent and non-reacted monomers or comonomers are returned to the reactor. In a preferred embodiment, the process according to the present disclosure may further comprise the removal of the residual volatile organic compounds (VOC) from the ethylene polymer.

In one or more embodiments, the reactor pressure is controlled by equalizing the vaporization rate of the liquid light hydrocarbon diluent in the reactor with the condensation rate of light hydrocarbon vapor in the slurry-free heat exchanger. The equalization between vaporization and condensation rates may be achieved, for example, by adjusting the flow rate of cooling media, such as cooling water, fed to the cooling system. In one or more embodiments, the sensor of the pressure controller operates in cascade with the cooling media flow rate controller. When there is an increase in reactor pressure due to liquid light hydrocarbon diluent vaporization, the pressure controller sends a signal to increase the cooling media flow rate to the slurry-free heat exchanger, increasing the condensation rate.

### Ethylene Polymer

In a second aspect, the present disclosure relates to an ethylene polymer produced by the process disclosed herein. An ethylene polymer is obtained by the process of any of the above claims. In a preferred embodiment, the ethylene polymer according to the present disclosure is a polyethylene having a viscosity average molecular weight (Mv) of from 0.05 to 0.2 Mg/mol. In a preferred embodiment, the ethylene polymer according to the present disclosure polymer is an VHMWPE having a viscosity average molecular weight (Mv) of from 0.2 Mg/mol to 3.0 Mg/mol. In a preferred embodiment, the ethylene polymer according to the present disclosure is a UHMWPE having a viscosity average molecular weight (Mv) of at least 3.0 Mg/mol.

### System for Producing an Ethylene Polymer

In a third aspect, the present disclosure relates to a system for producing an ethylene polymer comprising:
a polymerization reactor receiving a liquid light hydrocarbon diluent, ethylene, at least one catalyst, and optionally one or more comonomers configured to polymerize the ethylene and optionally the one or more comonomers into an ethylene polymer;
a cooling system fluidly connected to the polymerization reactor, wherein the cooling system is configured to condense a light hydrocarbon vapor produced from the polymerization reactor and return a condensed liquid light hydrocarbon to the reactor.

In a preferred embodiment, the system according to the present disclosure further comprises a separator connected to an outlet of the polymerization reactor, in which liquid light hydrocarbon diluent is separated from the ethylene polymer and it is returned to the polymerization reactor.

In a preferred embodiment, the system according to the present disclosure further comprises a volatile compound remover connected to an outlet of the separator comprising:
a filter for separating light hydrocarbon diluent vapors from the ethylene polymer, and
a condenser for condensing light hydrocarbon diluent vapors, wherein the system comprises means to convey the condensed liquid light hydrocarbon diluent to the reactor.

In a preferred embodiment, the system according to the present disclosure further comprises an additive apparatus connected to an outlet of the volatile compounds remover, wherein additives are combined with the ethylene polymer.

In a preferred embodiment, the system according to the present disclosure further comprises a screening apparatus connected to an outlet of the additive apparatus, configured to separate the ethylene polymer by particle size.

In a preferred embodiment, the system according to the present disclosure further comprises a blender connected to an outlet of the screening apparatus, configured to blend the ethylene polymer and additives.

In a preferred embodiment, the system according to the present disclosure further comprises a packing apparatus connected to an outlet of the blender, configured to package the ethylene polymer.

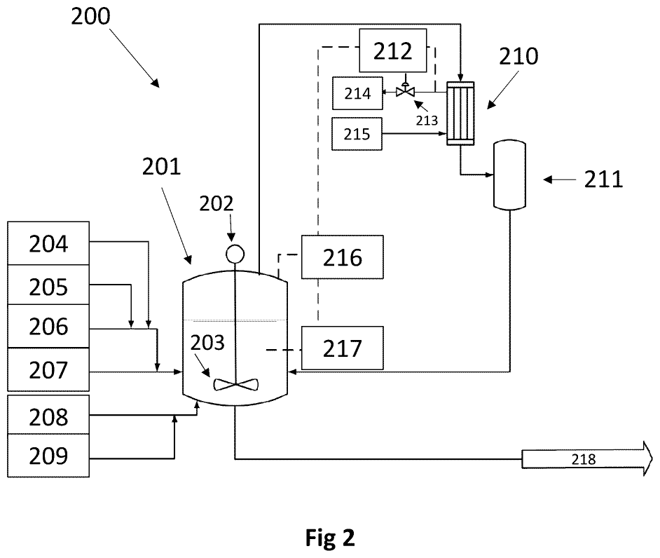

FIG. 2 shows a process flow diagram of a system 200 according to one or more embodiments comprising a reactor 201 fitted with a motor 202 and stirrer 203. The reactor is fed with hydrogen 204, comonomer 205, ethylene 206, light hydrocarbon diluent 207, catalyst 208, and a second liquid hydrocarbon diluent 209. The reactor is fluidly connected to a condenser 210 which is fluidly connected to a vessel 211 fluidly connected to the reactor to return condensed vapors to the reactor. The condenser is fitted with a flow controller 212 and a valve 213 to control the outflow of cooling water 214 from the condenser 210. The cooling water is supplied through a cooling water inlet or inflow 215. The reactor 210 is fitted with a pressure controller 216 and a temperature controller 217 to control the polymerization reaction. The produced ethylene polymer is recovered from the reactor via an outlet 218.

### METHODS OF ANALYSIS

### Definitions/Measuring Methods

Polymer Bulk Density (g/cm³)-polymer bulk density results were obtained according to ASTM D-1895.

Particle Size and Particle Size Distribution—the particle size distribution of powdered materials is determined through laser beam deflection, employing the Malvern Mastersizer 2000 equipment. This system is enhanced with the Hydro 2000S and Scirocco 2000 sample dispersion accessories. The operation involves the optical unit, which captures the light diffusion pattern within the particle field (sample) and subsequently calculates the size of the particles responsible for shaping the pattern.

Intrinsic Viscosity/Molecular Weight-analysis according to ASTM D-4020 was performed to determine the values of intrinsic viscosity (IV). The viscosity average molecular weight (Mv) is determined by the correlation between Mv and IV according to Equation I (Margolies equation):

$$Mv = 53700 * {10}^{1 , 49} \qquad ( I )$$

High Load Melt Index-analysis according to ASTM D1238, under a load of 21.6 kg at 190° C. was performed to determine the values of the high load melt index (HLMI).

### Examples

### Example 1-Batch Process

Polymerization of ethylene was operated in a batch stainless-steel reactor with a 3.9-liter capacity equipped with a manometer to record pressure variation of reaction, as well as to strictly control the temperature profile. The reactor was loaded with 935 g of propane and 242 mg of diethylaluminium chlorine. Then it was loaded with 10 mg of Ziegler-Natta catalyst. The mixture thus obtained was heated to a temperature of 80° C., at which point dry, deoxygenated ethylene was fed to the reaction system. The total system pressure was controlled at 38.5 barg. The agitation system was set at 1650 rpm, while the duration of the runs was equal to 80 minutes. It was produced 264 g of polyethylene. The reactor was then depressurized to vaporize the propane and terminate the reaction, and the resulting polyethylene was collected.

### Example 2-Continuous Process

Polymerization of ethylene with Ziegler-Natta catalyst was operated in a continuous stainless-steel reactor with a 40-liter capacity equipped with a pressure control system to get strict control of the reactor temperature by the liquid-vapor equilibrium condition maintained in the reactor. The diluent used was propane. The propane vaporized by the reaction heat generated in the ethylene polymerization was conducted to the condenser and then the condensed propane was sent back to the reactor. The flow rate of cooling water fed to the condenser was adjusted by the pressure control system to equalize the rate of propane condensation to the rate of propane evaporation in order to keep stable pressure and temperature, and also the liquid-vapor equilibrium according to the ethylene concentration in propane in the reactor headspace. The flow rate of propane fed to the reactor was controlled at 2.6 Kg/h and dry, deoxygenated ethylene was fed to the reaction system with a flow rate of 0.752 Kg/h. The flow rates of catalyst and diethylaluminium chlorine fed to the reactor were controlled, respectively, at 0.1 g/h and 310 mg/h. The pressure was controlled at 23 barg and the temperature was kept at 61° C. The polymerization was operated continuously for 172 hours, and no fouling was observed in the internal tubes of the condenser during this time. It was observed that a powder carryover can happen due to the velocity of the vapor phase, but it does not form fouling inside the tubes. The reactor level control was kept at a constant volume of 20 liters in the reactor by withdrawing the slurry produced in the ethylene polymerization from the reactor and conveying it to the flash gas system, where the non-reacted raw material and the diluent were evaporated, and the hydrocarbon-free powder was packed in bags.

### Example 3-Continuous Process with Comonomer

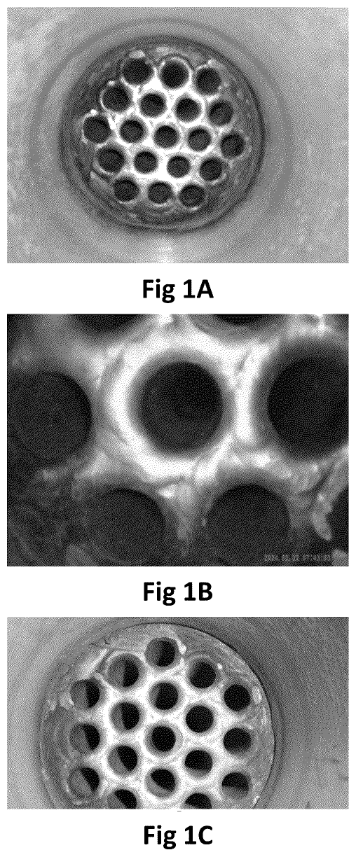

Polymerization of ethylene with Ziegler-Natta catalyst was operated in the system described in Example 2. The flow rate of propane fed to the reactor was controlled at 3.5 Kg/h and dry, deoxygenated ethylene was fed to the reaction system with a flow rate of 1.410 Kg/h. 1-butene comonomer was fed to the reactor with a flow rate of 5.6 g/h. The flow rates of catalyst and diethylaluminium chloride fed to the reactor were controlled, respectively, at 0.1 g/h and 290 mg/h. The pressure was controlled at 32.6 barg and the temperature was kept at 72° C. The polymerization was operated continuously for 95 hours and no fouling was observed in the internal tubes of the condenser during this time. FIG. 1B represent a picture of the condenser outlet after Example 3 was finalized. As Example 3 was operated right after Example 2, the results show that no fouling was formed during both examples 2 and 3. with as shown in FIG. 1B. The condenser ran without fouling forming. It was observed that a powder carryover can happen due to the velocity of vapor phase, but it does not formed fouling inside the tubes.

### Example 4-Continuous Process with Hydrogen

Polymerization of ethylene with Ziegler-Natta catalyst was operated in the system described in Example 2 with a hydrogen/ethylene ratio in the reactor headspace controlled at 0.20 mol H₂/mol ethylene. The flow rate of propane fed to the reactor was controlled at 3.5 Kg/h and dry, deoxygenated ethylene was fed to the reaction system with a feed rate of 0.815 Kg/h. The flow rates of catalyst and diethylaluminium chloride fed to the reactor were controlled, respectively, at 0.1 g/h and 290 mg/h. The pressure was controlled at 35 barg and the temperature was kept at 75° C. The polymerization was operated continuously for 246 hours and no fouling was observed in the internal tubes of the condenser during this time, as shown in FIG. 1C. The condenser ran without fouling forming. It was observed that a powder carryover can happen due to the velocity of vapor phase, but it does not formed fouling inside the tubes.

TABLE 1
Polymer Data

| Item | Unit | Example 1 | Example 2 | Example 3 | Example 4 |
|---|---|---|---|---|---|
| IV | dl/g | 27.9 | 26.8 | 24.5 | — |
| M_{w} | MMg/mol | 7.7 | 7.09 | 5.23 | — |
| Dp50 | μm | 199 | 205 | 229 | 153 |
| Bulk density | g/l | 0.42 | 0.43 | 0.41 | 0.41 |
| High Load | g/10 min | — | — | — | 2.5 |
| Melt Index | | | | | |

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed is:

1. A process for the polymerization of ethylene comprising:
introducing ethylene, a liquid light hydrocarbon diluent, at least one catalyst, at least one cocatalyst and optionally one or more comonomers into a reactor;
polymerizing the ethylene and optionally the one or more comonomers in the reactor to produce an ethylene polymer;
wherein the reactor is fluidly connected to a cooling system, the cooling system comprising a slurry-free heat exchanger, and the cooling system is configured to receive a vapor stream comprising light hydrocarbon vapor produced from the reactor.

2. The process according to claim 1, wherein the polymerization is a liquid-phase polymerization, preferably a suspension type polymerization wherein a slurry is formed inside the reactor.

3. The process according to claim 1, wherein polymerizing the ethylene occurs with the one or more comonomers, the one or more comonomers being preferably selected from alpha-olefin comonomers containing from 3 to 10 carbon atoms.

4. The process of claim 3, wherein the alpha-olefin comonomers are selected from propene, 1-butene, 1-hexene, 1-octene, or 1-decene.

5. The process of claim 1, wherein the liquid light hydrocarbon diluent used in the reactor is an alkane containing from 2 to 5 carbon atoms, preferably ethane, propane, butane, or isobutane.

6. The process of claim 1, wherein the catalyst is combined with the liquid light hydrocarbon diluent prior to introducing them into the reactor.

7. The process according to claim 1, further comprising adding one or more chain transfer agents.

8. The process according to claim 7, wherein the one or more chain transfer agents are selected from hydrogen, alkyl aluminum, or combinations thereof.

9. The process according to claim 1, wherein the at least one cocatalyst is premixed with the catalyst before getting into the reactor.

10. The process according to claim 1, wherein the cooling system is configured to condense the light hydrocarbon vapor into a condensed liquid light hydrocarbon.

11. The process according to claim 1, wherein the cooling system is a water cooling system.

12. The process according to claim 1, wherein the light hydrocarbon vapor is produced from the phase transition of the liquid light hydrocarbon introduced in the reactor.

13. The process according to claim 1, wherein the vapor stream produced from the reactor can have from 0.001 to 5% wt of solids based on the total weight of the vapor stream.

14. The process according to claim 12, wherein the phase transition of the liquid light hydrocarbon occurs by the heat of polymerization.

15. The process according to claim 1, wherein the condensed liquid light hydrocarbon is returned to the reactor by gravity or pumped after condensation in the cooling system.

16. The process according to claim 1, wherein the light hydrocarbon diluent fed to the reactor is substantially free of n-hexane.

17. The process according to claim 1, wherein the cocatalyst is selected from an alkyl aluminum cocatalyst.

18. The process of claim 10, wherein the reactor pressure is controlled by equalizing the vaporization rate of the liquid light hydrocarbon diluent in the reactor with the condensation rate of light hydrocarbon vapor in the slurry-free heat exchanger.

19. An ethylene polymer obtained by the process of claim 1.

20. A system for producing an ethylene polymer comprising:
a reactor receiving a liquid light hydrocarbon diluent, ethylene, at least one catalyst, and optionally one or more comonomers configured to polymerize the ethylene and optionally the one or more comonomers into an ethylene polymer;
a cooling system fluidly connected to the reactor, wherein the cooling system is configured to condense a gas-phase light hydrocarbon produced from the reactor and return a condensed liquid light hydrocarbon to the reactor.
